(19) United States
(12) Patent Application Publication
(10) Pub. No.: US 2026/0094583 A1
(43) Pub. Date: Apr. 2, 2026

(54) DRUM PEDAL SYSTEMS AND METHODS

(71) Applicant: Sergei Galkin, Arvada, CO (US)

(72) Inventor: Sergei Galkin, Arvada, CO (US)

(21) Appl. No.: 19/344,162

(22) Filed: Sep. 29, 2025

Related U.S. Application Data
(60) Provisional application No. 63/700,130, filed on Sep. 27, 2024.

(51) Int. Cl. G10D 13/11

(52) U.S. Cl. CPC G10D 13/11

(57) ABSTRACT

Drum pedal systems and methods are disclosed herein. Exemplary drum pedal assemblies include a footplate, a hoop clamp disposed at an anterior portion of the footplate, a footboard coupled with the footplate, a drive mechanism in operative association with the footplate and the footboard, and a beater. The lower portion of the beater is coupled with the anterior portion of the footplate via a fixed anterior hinge mechanism that is aligned toward the bottom or lower section of the drumhead.

### CROSS-REFERENCES TO RELATED APPLICATIONS

This application claims the benefit of U.S. Provisional Patent Application No. 63/700,130 filed Sep. 27, 2024, the disclosure of which is incorporated herein by reference.

### BACKGROUND OF THE INVENTION

Early drum pedal designs are described in U.S. Pat. No. 922,706. A typical bass drum pedal operates much the same as the hi-hat control. A footplate is pressed to pull a chain, belt, or metal drive mechanism downward, bringing a beater or mallet forward into the drumhead. The beater head is usually made of either felt, wood, plastic, or rubber and is attached to a rod-shaped metal shaft. The pedal and beater system are mounted in a metal frame and like the hi-hat, a tension unit controls the amount of pressure needed to strike and the amount of recoil upon release. Such current drum pedal designs are employed throughout the world. Yet there continues to be a need for new and improved drum pedal systems and methods. Embodiments of the instant invention address at least some of these outstanding needs.

### BRIEF SUMMARY OF THE INVENTION

Exemplary drum pedal systems and methods disclosed herein can provide unique timbre qualities, for example in a bass drum.

In a first aspect, embodiments of the present invention encompass drum pedal assemblies, and methods of their use and manufacture. Exemplary drum pedal assemblies can include a footplate having an anterior portion and a posterior portion, a hoop clamp disposed at the anterior portion of the footplate, where the hoop clamp is configured to fix a drum relative to the footplate, the drum having a drumhead. Assemblies can also include a footboard having an anterior portion and a posterior portion, where the posterior portion of the footboard is coupled with the posterior portion of the footplate via a fixed posterior hinge mechanism, and a drive mechanism in operative association with the footplate and the footboard. The drive mechanism can include a first linkage arm, a second linkage arm, and a roller mechanism, where the footboard is coupled with the first linkage arm via a posterior moving hinge mechanism, where the first linkage arm is coupled with the second linkage arm via an intermediate moving hinge mechanism, and where the second linkage arm is coupled with the beater via lower portion of the beater via an anterior moving hinge mechanism. Assemblies can further include a beater having an upper portion, a lower portion, and an attack surface.

In some cases, the lower portion of the beater is coupled with the anterior portion of the footplate via a fixed anterior hinge mechanism. In some cases, the lower portion of the beater is in operative association with the drive mechanism. In some cases, the attack surface of the beater is configured to flatly meet a slap zone of the drumhead across an engagement interface when the beater is actuated by the drive mechanism. In some cases, the engagement interface has an upper portion disposed between an upper portion of the attack surface and an upper portion of the slap zone, and a lower portion disposed between a lower portion of the attack surface and a lower portion of the slap zone. In some cases, the slap zone of the drumhead extends between a lower portion of the drumhead and a central portion of the drumhead. In some cases, a bottom of the beater is configured to contact a location on the drumhead that is a distance from a bottom of the drumhead, and the distance has a value within a range from 1 mm to 10 mm. In some cases, the distance is selected so that when the beater contacts the drumhead during use, a slap effect is achieved instead of a beating effect. In some cases, the distance has a value within a range from 1 mm to 10 mm. In some cases, the distance has a value within a range from 2 mm to 9 mm. In some cases, the distance has a value within a range from 3 mm to 8 mm. In some cases, the distance has a value within a range from 4 mm to 7 mm. In some cases, the distance has a value within a range from 5 mm to 6 mm. In some cases, the distance has a value within a range from 0.5 mm to 15 mm. In some cases, the distance D has a value within a range from 1 mm to 15 mm.

In some cases, the roller mechanism includes a roller, and the footplate includes or is coupled with a track that is configured to engage the roller. In some cases, a drum pedal assembly can include a return mechanism that is configured to return the beater toward a resting or original position when pressure on the footboard decreased or removed. In some cases, the return mechanism includes a return spring. In some cases, the return spring includes a posterior portion that is coupled with the footplate, and an anterior portion which is coupled with the beater. In some cases, the anterior hinge mechanism is disposed inferior to the anterior portion of the footboard throughout actuation of the beater.

In another aspect, embodiments of the present invention encompass drum pedal assemblies that include a footplate, a hoop clamp, a footboard, a drive mechanism, and a beater. In some cases, a footplate includes an anterior portion and a posterior portion. In some cases, a hoop clamp is disposed at the anterior portion of the footplate, and the hoop clamp is configured to fix a drum relative to the footplate, and the drum has a drumhead. In some cases, the footboard has an anterior portion and a posterior portion, and the posterior portion of the footboard is coupled with the posterior portion of the footplate via a fixed posterior hinge mechanism. In some cases, the drive mechanism is in operative association with the footplate and the footboard. In some cases, the beater has an upper portion, a lower portion, and an attack surface. In some cases, the lower portion of the beater is coupled with the anterior portion of the footplate via a fixed anterior hinge mechanism. In some cases, the lower portion of the beater is in operative association with the drive mechanism. In some cases, the attack surface of the beater is configured to flatly meet a slap zone of the drumhead across an engagement interface when the beater is actuated by the drive mechanism. In some cases, the engagement interface has an upper portion disposed between an upper portion of the attack surface and an upper portion of the slap zone, and a lower portion disposed between a lower portion of the attack surface and a lower portion of the slap zone. In some cases, the slap zone of the drumhead extends between a lower portion of the drumhead and a central portion of the drumhead.

In some cases, the drive mechanism includes a first linkage arm, a second linkage arm, and a roller mechanism. In some cases, the footboard is coupled with the first linkage arm via a posterior moving hinge mechanism, the first linkage arm is coupled with the second linkage arm via an intermediate moving hinge mechanism, and the second linkage arm is coupled with the beater via lower portion of the beater via an anterior moving hinge mechanism. In some cases, the roller mechanism includes a roller, and the footplate includes or is coupled with a track that is configured to engage the roller. In some cases, the drum pedal assembly includes a return mechanism that is configured to return the beater toward a resting position when pressure on the footboard decreased. In some cases, the return mechanism includes a return spring. In some cases, the return spring includes a posterior portion that is coupled with the footplate, and an anterior portion which is coupled with the beater. In some cases, the anterior hinge mechanism is disposed inferior to the anterior portion of the footboard throughout actuation of the beater. In some cases, a bottom of the beater is configured to contact a location on the drumhead that is a distance from a bottom of the drumhead, and the distance has a value within a range from 1 mm to 10 mm. In some cases, the distance is selected so that when the beater contacts the drumhead during use, a slap effect is achieved instead of a beating effect. In some cases, the distance has a value within a range from 2 mm to 9 mm. In some cases, the distance has a value within a range from 3 mm to 8 mm. In some cases, the distance has a value within a range from 4 mm to 7 mm. In some cases, the distance has a value within a range from 5 mm to 6 mm. In some cases, the distance has a value within a range from 0.5 mm to 15 mm. In some cases, the distance has a value within a range from 1 mm to 15 mm.

### BRIEF DESCRIPTION OF THE DRAWINGS

Novel features of exemplary drum pedal assemblies and their methods of use and manufacture are set forth with particularity in the appended claims. A better understanding of the features and advantages of the provided system and methods will be obtained by reference to the following detailed description that sets forth illustrative embodiments, in which the principles of the invention are utilized, and the accompanying drawings of which:

FIGS. 1A to 1F illustrate aspects of a drum pedal assembly, according to embodiments of the present invention;

FIGS. 2A and 2B illustrate aspects of a drum pedal assembly, according to embodiments of the present invention;

FIGS. 3A and 3B illustrate aspects of a drum pedal assembly, according to embodiments of the present invention;

FIG. 4 illustrates aspects of a drum pedal assembly, according to embodiments of the present invention;

FIGS. 5A and 5B illustrate aspects of a conventional drum pedal assembly;

FIGS. 6A to 6C illustrate aspects of a drum pedal assembly, according to embodiments of the present invention;

FIG. 7 illustrates aspects of a drum pedal assembly, according to embodiments of the present invention;

FIG. 8 illustrates aspects of a drum pedal assembly, according to embodiments of the present invention; and

FIG. 9 illustrates aspects of a drum pedal assembly, according to embodiments of the present invention.

### DETAILED DESCRIPTION OF THE INVENTION

All illustrations of the drawings are to be describing selected embodiments of the present invention and are not intended to limit the scope of the present invention. All references of user or users encompass either individual or individuals who would utilize embodiments of the present invention. Exemplary embodiments encompass drum pedal assemblies, and methods of their use and manufacture. Component parts shown in the drawings are not necessarily to scale, and may be exaggerated to better illustrate the important features of the present disclosure. Directional or positional references (e.g., proximal, distal, upper, lower, upward, downward, left, right, lateral, longitudinal, front, back, top, bottom, above, below, vertical, horizontal, radial, axial, clockwise, counterclockwise, and the like) are used for identification purposes to aid the reader's understanding of the present devices, systems, and structures described herein, and do not create limitations, particularly as to the position, orientation, or use of embodiments of the invention. In some cases, such references may be used interchangeably with other terms such as first, second, and the like. Connection references (e.g., attached, coupled, connected, joined, and the like) may be construed broadly and may include intermediate members between a collection of elements and relative movement between elements unless otherwise indicated. Nothing in this detailed description is intended to imply that any particular component, feature, or step is essential to embodiments of the invention.

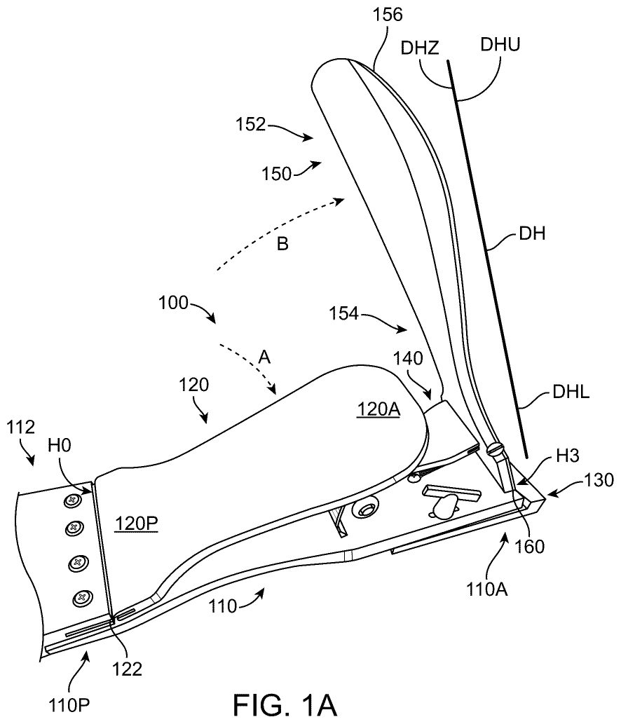

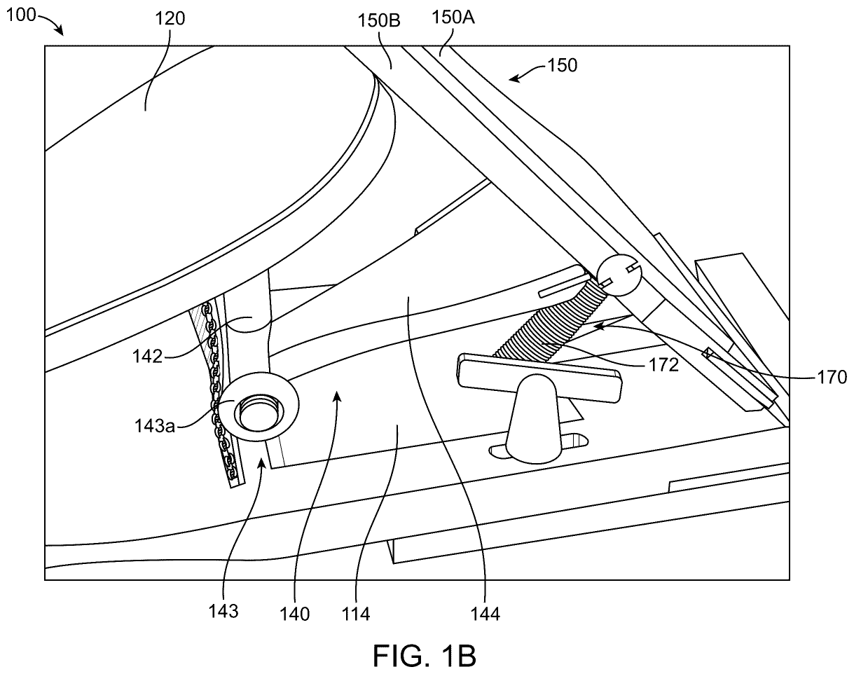

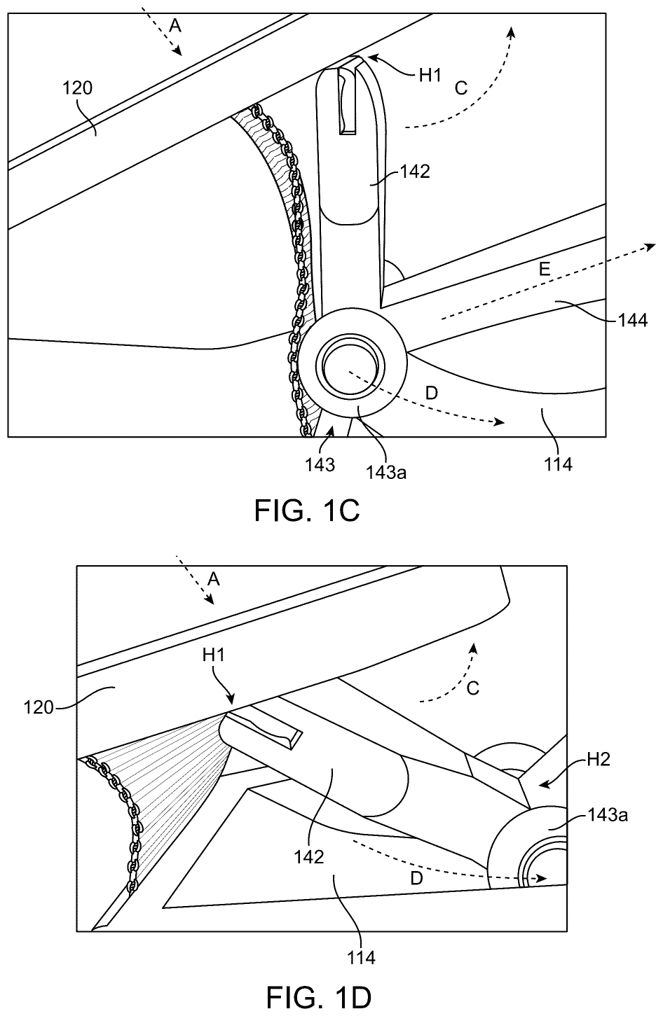

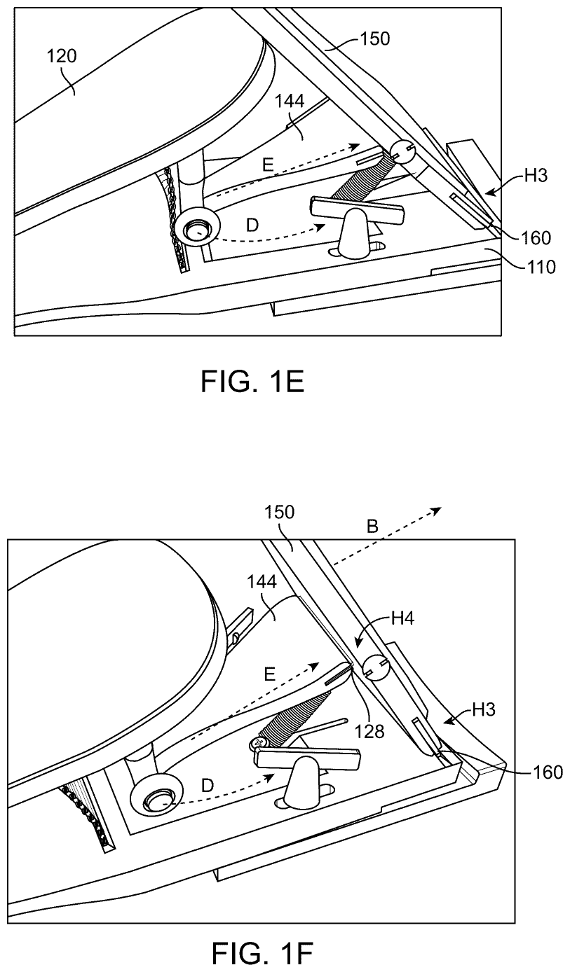

FIG. 1A depicts aspects of a drum pedal assembly 100 according to embodiments of the present invention. As shown here, drum pedal assembly 100 includes a footplate 110, a heelplate 112, a footboard 120, a hoop clamp 130, a drive mechanism 140, and a beater 150. Footplate 110 includes an anterior portion 110A and a posterior portion 110P. Footboard 120 includes an anterior portion 120A and a posterior portion 120P. As shown here, hoop clamp 130 is disposed at the anterior portion 110A of footplate 110, and hoop clamp 130 is configured to fix a drum relative to the footplate 110, where the drum includes a drumhead DH.

In operation, when the footboard 120 is depressed as indicated by arrow A, the beater 150 pivots about beater swing axis 160 (e.g. via a hinge mechanism H0), and toward a drum head DH of a drum as indicated by arrow B. This is accomplished by operation of the drive mechanism 140, which provides a mechanical linkage between footboard 120 and beater 150. As shown here, footboard 120 can pivot about a footboard axis 122 (e.g. via hinge mechanism H3), relative to footplate 110. A hinge mechanism H0 can enable footboard 120 to pivot relative to footplate 110. In this embodiment, hinge mechanism H0 is fixed (e.g. providing a fixed pivot and/or axis). Similarly, hinge mechanism H3 is fixed (e.g. providing a fixed pivot and/or axis).

Hinge mechanisms H0 and H3 can be provided in any of a variety of hinge embodiments, including without limitation ball bearing hinges, butt hinges, barrel hinges, concealed hinges, knife hinges, pivot hinges, overlay hinges, offset hinges, piano hinges, strap hinges, strap hinges, living hinges, and the like. In some cases, a hinge mechanism can include a sheet or strip of flexible material such as leather or synthetic leather, which is laminated in adjacent veneer stacks or otherwise secured to adjacent wooden or other rigid materials.

As shown here, posterior portion 120P of footboard 120 can be coupled with posterior portion 110P of footplate 110 via a posterior hinge mechanism (e.g. hinge mechanism H0). Drive mechanism 140 is in operative association with footboard 120, footplate 110, and beater 150. According to some embodiments, beater 150 includes an upper portion 152, a lower portion 154, and an attack surface 156. The lower portion 154 of beater 150 can be coupled with anterior portion 110A of footplate 110 via an anterior hinge mechanism H3. The lower portion 154 of beater 150 can also be in operative association with drive mechanism 140. Attack surface 156 of beater 150 can be configured to flatly meet a slap zone DHZ of drumhead DH across an interface surface when beater 150 is actuated by drive mechanism 140. The slap zone DHZ of drumhead DH can extend between a lower portion DHL of drumhead DH and an upper portion DHU of drumhead DH.

As depicted in FIG. 1B, drum pedal assembly 100 can also include a return mechanism 170 which operates to return the beater 150 toward its original or resting position when pressure on the footboard 120 is removed or decreased. In some embodiments, as shown here, return mechanism 170 includes a return spring 172. Drive mechanism 140 includes a first linkage arm 142, a second linkage arm 144, and a roller mechanism 143. Footplate 110 includes a track 114 configured to receive or engage a roller 143a of roller mechanism 143. In some cases, track 114 can be provided as or include a scooped or curved surface. First linkage arm 142 extends between footboard 120 and roller mechanism 143. Second linkage arm 144 extends between first linkage arm 142 and beater 150. In some embodiments, beater 150 can include both a pad 150A and a main body 150B.

As depicted in FIG. 1C, first linkage arm 142 can pivot relative to footboard 120 as indicated by arrow C, when footboard 120 is depressed as indicated by arrow A. This pivoting action can be enabled by a hinge mechanism H1. As shown here, hinge mechanism H1 provides a pivotal coupling between footboard 120 and first linkage arm 142. Because hinge mechanism H1 moves throughout a range of motion during actuation, hinge mechanism can be H1 considered as a moving pivot. In facilitation of such pivoting of first linkage arm 142, roller 143a of roller mechanism 143 rolls along track 114 in the direction indicated by arrow D. In turn, second linkage arm 144 is advanced in a forward or anterior direction, as indicated by arrow E.

As depicted in FIG. 1D, as footboard 120 is continued to be depressed as indicated by arrow A, first linkage arm 142 continues to pivot relative to footboard 120 as indicated by arrow C, and roller 143a continues to roll along the track as indicated by arrow D. In this embodiment, a first hinge mechanism H1 enables pivoting between footboard 120 and first linkage arm 142, and a second hinge mechanism H2 enables pivoting between first linkage arm 142 and second linkage arm 144. Hinge mechanisms H1 and H2 can be considered to be moving (e.g. providing moving pivots and/or axes). Track 114 can have a curved or “U” shaped profile. As such, roller 143a can move between a raised position (e.g. as shown in FIG. 1C) and a lowered position (e.g. as shown in FIG. 1D).

By comparing FIGS. 1E and 1F, it can be seen that as second linkage arm 144 is advanced in the forward or anterior direction, as indicated by arrow E, beater 150 pivots about beater swing axis 160 relative to footplate 110 in the direction indicated by arrow B, via a third or anterior hinge mechanism H3, while second linkage arm 144 pivots relative to fifth axis 128, via a fourth hinge mechanism H4. In this embodiment, hinge mechanism H3 is fixed (e.g. providing a fixed pivot and/or axis, which is stationary in space) and hinge mechanism H4 is moving (e.g. providing a moving pivot and/or axis, which is moving in space). During actuation of the footboard 120, the rolling mechanism remains in a low position, rolling along an upper surface (e.g. track) of the footplate 110. Relatedly, the linkage arm toward the anterior of the drive mechanism (e.g. linkage arm 144) remains in a low position as well as it is advanced from a posterior position toward an anterior position. The hinge mechanism connecting the drive mechanism with the beater (e.g. hinge mechanism H4) remains in a low position as well, for example as shown here closer to the bottom of the beater. The horizontal vector of movement associated with the linkage arm 144 also remains low and close to the footplate, the horizontal vector extending from a posterior location toward an anterior location. The drive mechanism enables the conversion of a portion of the downward movement of the footboard into a forward movement of the linkage arm 144. In some embodiments, a drum pedal assembly can enable a forward horizontal translational movement of the beater, rather than a pivoting movement of the beater.

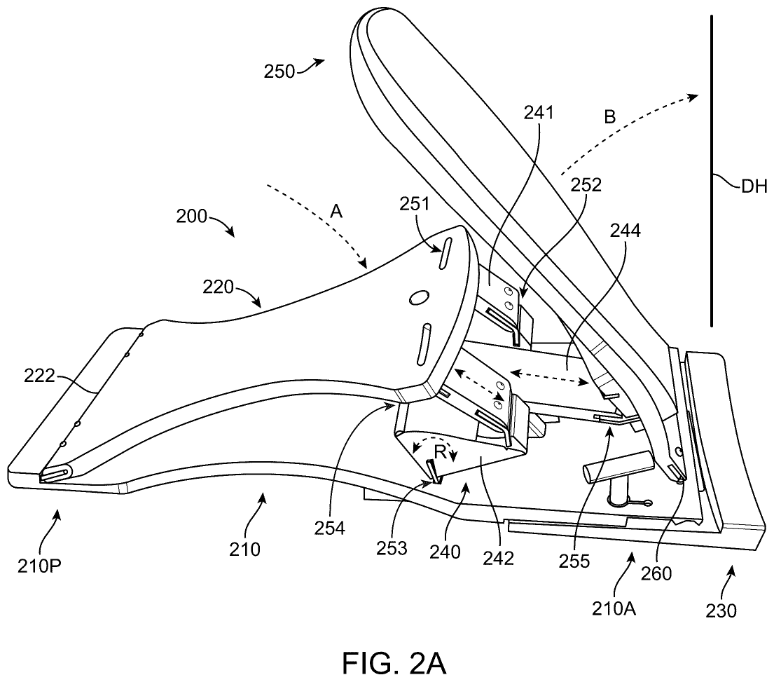

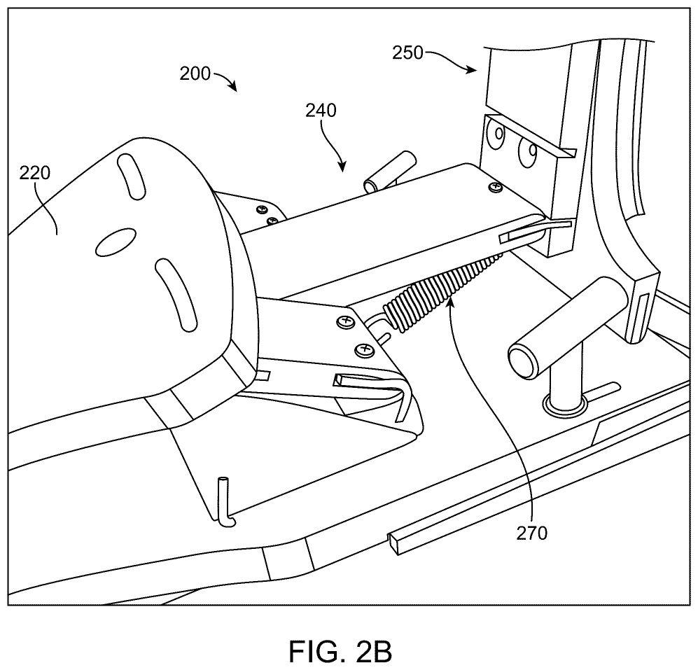

FIG. 2A depicts aspects of a drum pedal assembly 200 according to embodiments of the present invention. As shown here, drum pedal assembly 200 includes a footplate 210, a footboard 220, a hoop clamp 230, a drive mechanism 240, and a beater 250. Footplate 210 includes an anterior portion 210A and a posterior portion 210P. In operation, when the footboard 220 is depressed as indicated by arrow A, the beater 250 pivots about beater swing axis 260, and toward a drum head DH of a drum as indicated by arrow B. This is accomplished by operation of the drive mechanism 240, which provides a mechanical linkage between footboard 220 and beater 250. As shown here, footboard 220 can pivot about a footboard axis 222, relative to footplate 210. As depicted in FIG. 2B, drum pedal assembly 200 can also include a return spring mechanism 270 which operates to return the beater 250 toward its original or resting position when pressure on the footboard 220 is removed.

As depicted here, drive mechanism 240 actuates via operation of coupling sequence (between footboard and beater) that includes first moving hinge mechanism 251, first linkage arm 241, second moving hinge mechanism 252, second linkage arm 242, first fixed hinge mechanism 253, third moving hinge mechanism 254, fourth linkage arm 244, and fourth moving hinge mechanism 255. In some cases, second linkage arm 242 operates as a rocker (e.g. see arrow R), with a fixed hinge at the lower section thereof and two moving hinges at the upper section thereof. During actuation of the footboard 220, the lower pivot of the rocker (e.g. at hinge mechanism 253) remains in a low position (e.g. close to the footplate 210), as the rocker or second linkage arm 242 rocks from a posterior orientation toward an anterior orientation. Relatedly, the linkage arm toward the anterior of the drive mechanism (e.g. linkage arm 244) remains in a low position as well as it is advanced from a posterior position toward an anterior position. The hinge mechanism connecting the drive mechanism with the beater (e.g. hinge mechanism 255) remains in a low position as well, for example as shown here closer to the bottom of the beater. The horizontal vector of movement associated with the linkage arm 244 also remains low and close to the footplate, the horizontal vector extending from a posterior location toward an anterior location. The drive mechanism enables the conversion of a portion of the downward movement of the footboard into a forward movement of the linkage arm 244.

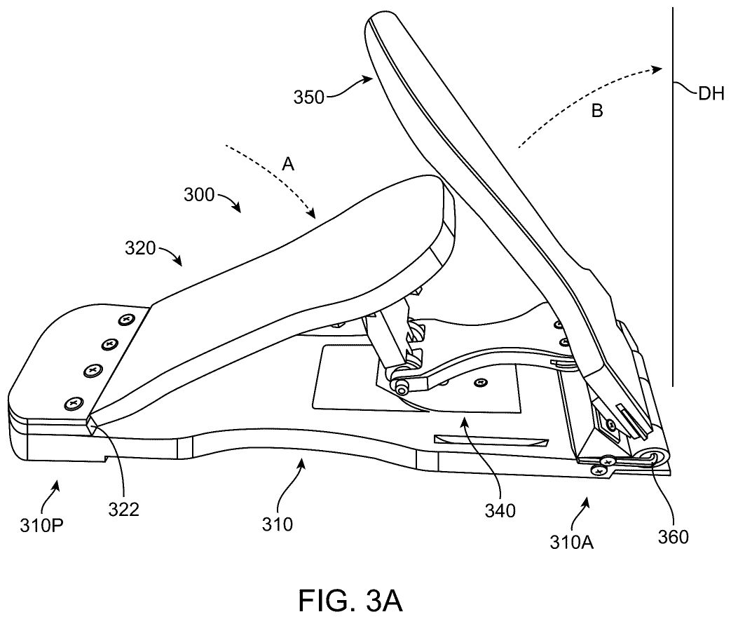

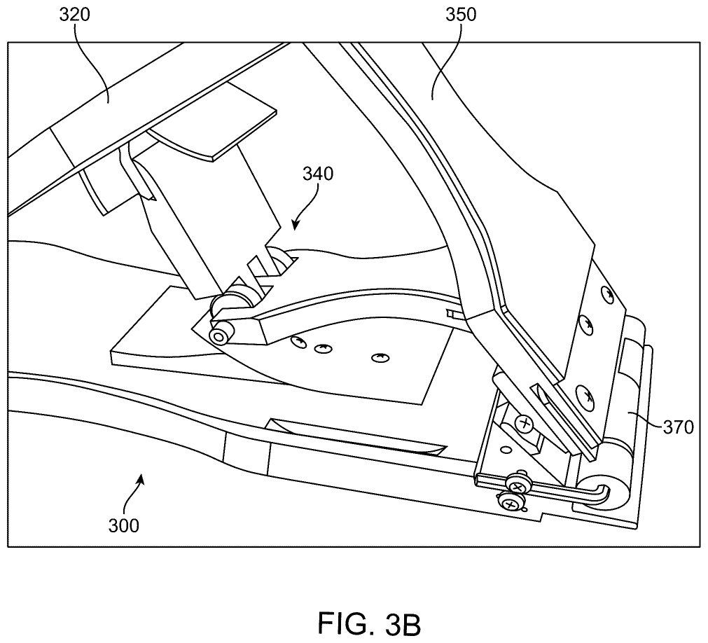

FIG. 3A depicts aspects of a drum pedal assembly 300 according to embodiments of the present invention. As shown here, drum pedal assembly 300 includes a footplate 310, a footboard 320, a drive mechanism 340, and a beater 350. Footplate 310 includes an anterior portion 310A and a posterior portion 310P. In operation, when the footboard 320 is depressed as indicated by arrow A, the beater 350 pivots about beater swing axis 360, and toward a drum head DH of a drum as indicated by arrow B. This is accomplished by operation of the drive mechanism 340, which provides a mechanical linkage between footboard 320 and beater 350. As shown here, footboard 320 can pivot about a footboard axis 322, relative to footplate 310. As depicted in FIG. 3B, drum pedal assembly 300 can also include a return spring mechanism 370 which operates to return the beater 350 toward its original or resting position when pressure on the footboard 320 is removed. During actuation of the footboard 320, the rolling mechanism remains in a low position, rolling along an upper surface (e.g. track) of the footplate 310. Relatedly, the linkage arm toward the anterior of the drive mechanism remains in a low position as well as it is advanced from a posterior position toward an anterior position. The hinge mechanism connecting the drive mechanism with the beater remains in a low position as well, for example as shown here closer to the bottom of the beater. The horizontal vector of movement associated with the anterior linkage arm of the drive mechanism also remains low and close to the footplate, the horizontal vector extending from a posterior location toward an anterior location. The drive mechanism enables the conversion of a portion of the downward movement of the footboard into a forward movement of the anterior linkage arm of the drive mechanism.

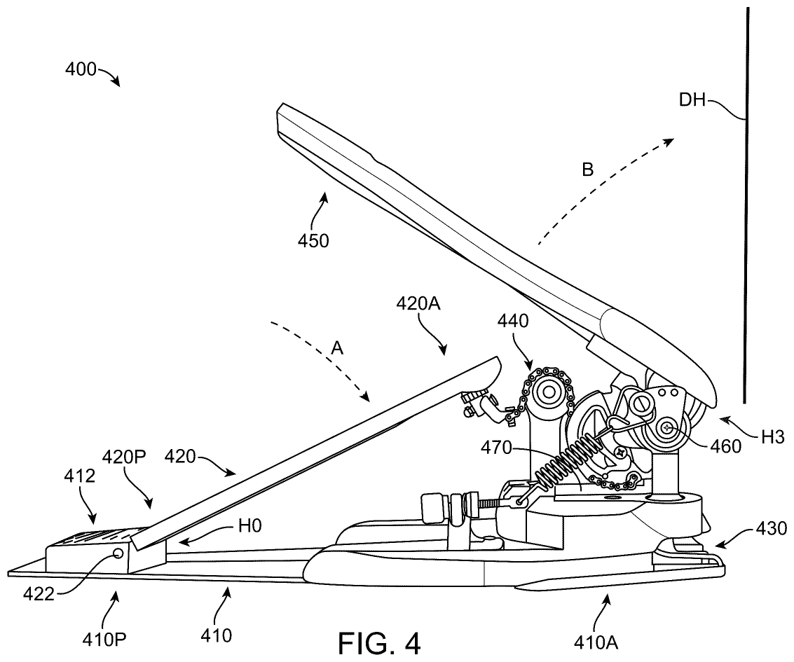

FIG. 4 depicts aspects of a drum pedal assembly 400 according to embodiments of the present invention. As shown here, drum pedal assembly 400 includes a footplate 410, a heelplate 412, a footboard 420, a hoop clamp 430, a drive mechanism 440, and a beater 450. Footplate 410 includes an anterior portion 410A and a posterior portion 410P. Hoop clamp 430 is disposed at the anterior portion 410A of the footplate 410, and the hoop clamp 430 is configured to fix a drum relative to the footplate 410, and the drum includes a drumhead DH. Footboard 420 has an anterior portion 420A and a posterior portion 420P. Posterior portion 420P of footboard 420 is coupled with posterior portion 410P of footplate 410, for example either directly, or via heelplate 412.

As shown here, the drum pedal assembly 400 includes a posterior hinge mechanism H0 by which footboard 420 can pivot relative to footplate 410. In operation, when the footboard 420 is depressed as indicated by arrow A, the beater 450 pivots about beater swing axis 460, and toward a drum head DH of a drum as indicated by arrow B. This is accomplished by operation of the drive mechanism 440, which provides a mechanical linkage between footboard 420 and beater 450. Drive mechanism 440 can be coupled with or in operative association with footplate 410 and footboard 420. A lower portion of the beater 450 can be coupled with the anterior portion 410A of the footplate 410 via an anterior hinge mechanism H3. As shown here, footboard 420 can pivot about a footboard axis 422, relative to footplate 410. The assembly 400 also includes a return spring mechanism 470 which operates to return the beater 450 toward its original or resting position when pressure on the footboard 420 is removed.

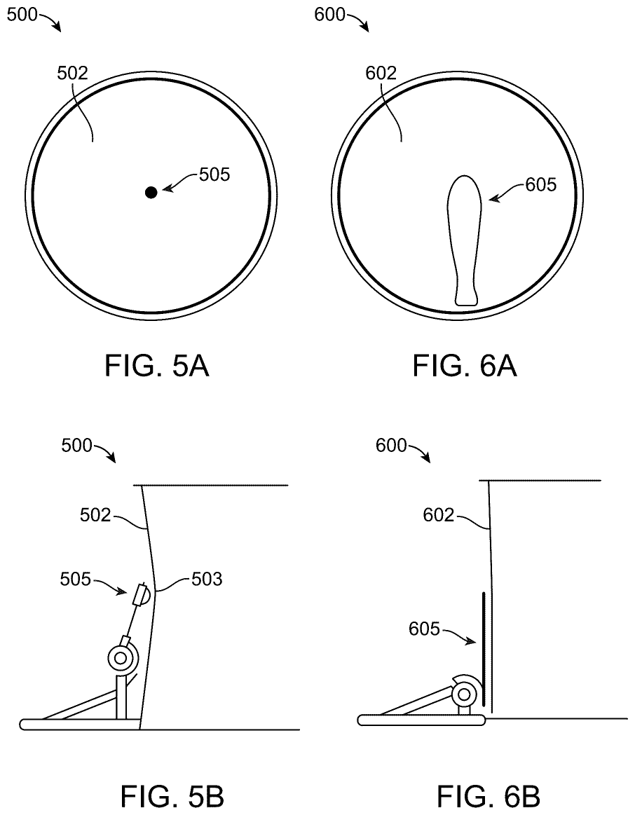

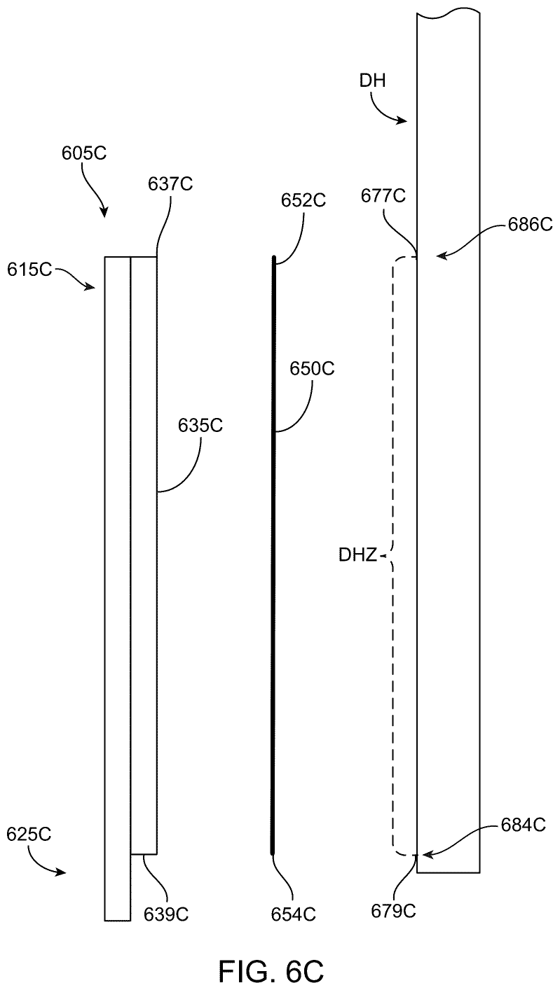

Differences between a conventional drum pedal beater 505 and a unique drum pedal beater 605 as disclosed herein can be understood when comparing FIGS. 5A and 5B (conventional beater 505) with FIGS. 6A and 6B (unique beater 605). For example, it can be seen that the locations and areas at which the respective beaters the contact drum heads 502 and 602 of the respective drums 500 and 600 are significantly different. When comparing FIGS. 5A and 6A, it can be seen that there is a difference in the contact area of the beater and the drum head. For example, drum pedal beater 605 provides a contact area between the beater 605 and the drum head 602 that is tens of times larger than the conventional system (i.e. there is a smaller contact area between the beater 505 and the drum head 502). Due to this unique design of beater 605, the sound of the drum 600 becomes different when contacted by beater 605. When using beater 605, a different attack appears with a claps or slap effect.

In understanding aspects of the innovative drum pedal designs disclosed herein, it is also helpful to consider the concept of inward deflection in a drum head. During intense play on a conventional pedal, when the beater 505 hits the drum head 502, the center 503 of the drum head 502 can deflect inward up at a significant distance (e.g. to two inches), depending on the tension of the drum head, as illustrated in FIG. 5B.

In contrast, when playing on the innovative pedal systems disclosed herein, which can include a beater 605 as shown in FIG. 6B, the drum head can deflect inward much less. The large area of the beater 605 does not give a large deflection of the drum head 602. For example, the maximum deflection can be one half inch. As an analogy, it may be helpful to consider pressing one's finger against a hard mattress and comparing that effect with that of pressing one's palm against the same hard mattress. With one's finger, it is possible to press on the mattress deeper than with the palm. This happens because the area of the finger is smaller than the area of the palm. A similar principle can operate here. For example, the area of the conventional beater 505 is much smaller than the area of an innovative beater 605. In some cases, an innovative beater 605 of this shape can be slightly heavier than a conventional beater 505. It has been observed through testing in a recording studio that innovative beater configurations such as beater 605 can provide a bright attack (e.g. brighter than that provided by a conventional beater 505). Relatedly, it has been observed through testing in a recording studio that innovative beater configurations such as beater 605 can produce sound having low frequencies (e.g. lower than that provided by a conventional beater 505. Beater configurations such as beater 605 can also be advantageous over conventional beaters (e.g. beater 505) because a beater 605 can be operated without requiring or using a protector on the drum head. This is because beater 605 places less wear and tear on the drum head, as compared with a conventional beater 505.

It is also useful to consider the shape of the beater. A conventional beater 505 operates to beat in the center of the drum. Having a round head made of hard or soft materials, the beater 505 has not changed for many decades, almost 100 years. Exemplary embodiments of a beater disclosed herein, for example beater 605, can also be referred to as a slapper. Beater 605 not only hits the drum head, but it also slaps the drum head. Because of this property, the shape of beater 605 can be more complex than that of a conventional beater 505. It is helpful to understand the physics of slapping. Relatedly, the ratio of the area (proportions) of the slapper and what is slapped is helpful to consider. Further, the ratio of their weight is helpful to consider. The bass drum is typically quite heavy, and relatedly, the drum head of a bass drum can be quite heavy. And for a bass drum to produce a desired sound (e.g. loud and low sound), the weight of the beater 605 can be selected with intent. Not excessively light, otherwise the beater will not swing (resonate) the head drum, but not excessively heavy, otherwise there will be no speed in the drummer's play and the head drum (e.g. plastic) can be damaged.

In a conventional beater 505, the main weight, and therefore the striking force, is concentrated in the round head of the beater 505. With all its weight, it hits approximately in the middle 503 of the drum head 502. In the presented innovative form of the beater 605, the striking force can be distributed over the entire plane of the beater 605. In some cases, it is possible to determine the desired shape and weight of the beater based on the desired sound to be produced.

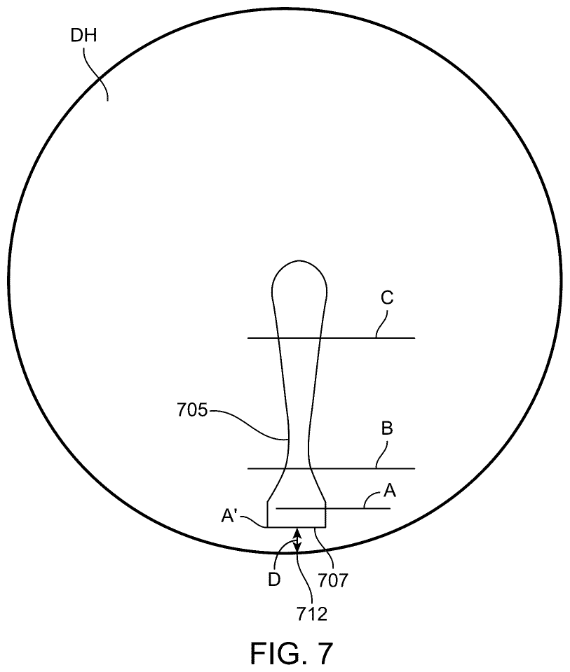

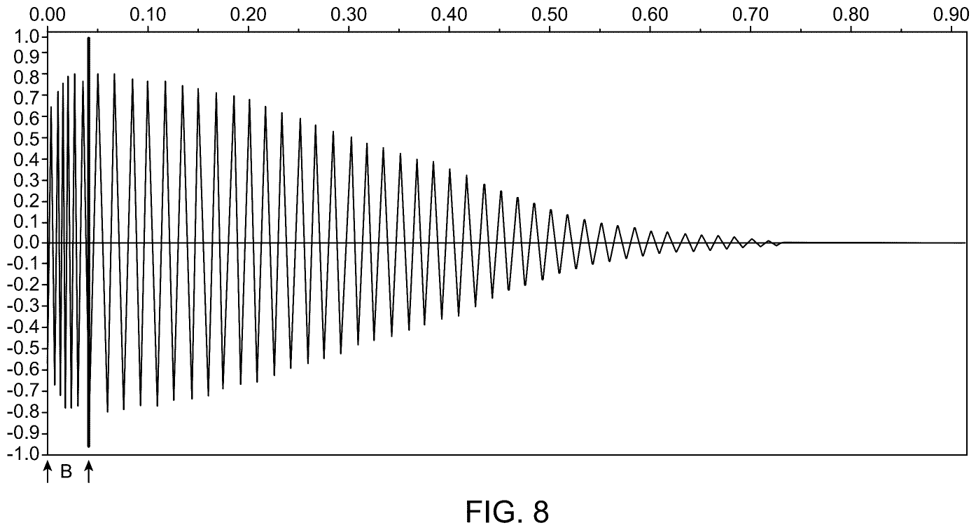

In some cases, it is helpful to consider conditions that can be effective or helpful for extracting a high-quality drum sound with a new beater 605, as follows. In some embodiments, it may be helpful to consider the force of the beater's impact. In some cases, the impact of the beater 605 can be distributed evenly across the area of the drum head as contacted by the beater. In some cases, the impact of the beater 605 can be distributed somewhat unevenly across the area of the drum head as contacted by the beater. In some cases, the main impact achieved with the beater 605 can be in or toward the middle of the head drum or close to the middle. In some cases, the main impact achieved with the beater 605 can be in or toward the periphery of the head drum or away from the middle. In some embodiments, to get a slap, the beater 605 can operate to hit with its entire plane. In some embodiments, due to the increase in the shape of the beater (e.g. greater surface area, as compared with conventional beater), it can be helpful for the beater 605 to maintain its lightness and fast operation without compromising the force of the impact on the drum head. One or more of these conditions can be considered when forming the shape of an innovative beater 605, as disclosed herein (see e.g. FIG. 7).

FIG. 6C depicts a side view of a beater 605C according to embodiments of the present invention. As shown here, beater 605C includes an upper portion 615C, a lower portion 625C, and an attack surface 635C. The lower portion 625C of the beater 605C can be coupled with an anterior portion of a footplate, for example via an anterior hinge mechanism, as disclosed elsewhere herein. The attack surface 635C of the beater 605C can be configured to flatly meet a slap zone DHZ of the drumhead DH across an engagement interface 650C when the beater 605C is actuated (e.g. by a drive mechanism). As shown here, the engagement interface 650C has an upper portion 652C disposed between an upper portion 637C of the attack surface 635C and an upper portion 677C of the slap zone DHZ, and a lower portion 654C disposed between a lower portion 639C of the attack surface 635C and a lower portion 679C of the slap zone DHZ. The slap zone DHZ of the drumhead DH extends between a lower portion 684C of the drumhead DH and a central portion 686C of the drumhead DH. In some cases, the length of the attack surface 635C can be about 100% of the radius of the drumhead DH. In some cases, the length of the attack surface 635C can be about 95% of the radius of the drumhead DH. In some cases, the length of the attack surface 635C can be about 90% of the radius of the drumhead DH. In some cases, the length of the attack surface 635C can be about 85% of the radius of the drumhead DH. In some cases, the length of the attack surface 635C can be about 80% of the radius of the drumhead DH. In some cases, the length of the attack surface 635C can have a value within a range from about 60% of the radius of the drumhead to about 100% of the radius of the drumhead DH.

As shown in FIG. 7, the beater 705 can be fixed on the A axis. For example, axis A can correspond to a fixed pivot about which beater 705 pivots or rotates. As shown here, axis A is slightly above the bottom edge of the beater 705. In some cases, the beater can be fixed on the A′ axis. For example, axis A′ can correspond to a fixed pivot about which beater 705 pivots or rotates. As shown here, axis A′ is at the bottom edge of the beater 705. By providing a low pivot axis (e.g. either A or A′), a next higher portion of the beater (e.g. portion B) can be slightly more mobile than the portion of the beater that is at the pivot axis. Accordingly, the weight of this part B of the beater 705 may not be significantly felt or noticed by the drummer during play. As shown here, the width of the beater 705 at portion B is less than the width of the beater 705 at axis A (or axis A′).

From the B portion to a next higher portion of the beater 705 (e.g. portion C), the beater 705 can vary in width as depicted here, for example thinning slightly above portion B and then expanding as the height reaches toward portion C. In some cases, the thickness (not depicted in this two-dimensional representation of FIG. 7) of the beater 705 can vary as well, at desired locations along the length of the beater. By selecting the desired width and/or thickness, it is possible to achieve a desired corresponding mass of the beater at selected locations along the length of the beater. Similarly, the material composition of the beater 705 can be varied at selected locations. For example, the beater 705 can include a material of a first mass at a first location, and a material of a second mass at a second location, where the value of the first mass is different (i.e. greater than or less than) the value of the second mass. In an exemplary configuration (e.g. as shown here), the mass of the beater can be reduced as desired, but its area can remain significantly large to form the desired sound of the slap.

From the C portion to the top of the beater 705, the beater 705 can vary in width as depicted here, for example at first expanding above portion C, and then thinning in width toward the top of the beater 705. In some cases, the portion of the beater that is between portion C and the top can be the heaviest portion of the beater. In some cases, the portion of the beater than is between portion C and the top can be sufficiently heavy as desired, so as to achieve the desired sound when contacting the drum head. In some cases, the portion of the beater that is between portion C and the top can be similar or equivalent in weight to an entire conventional beater. In some cases, the portion of the beater that is between portion C and the top can provide a striking area (e.g. contact area between beater and drum head) that is larger than the striking area provided by a conventional beater. With approaches such as those described herein, it is possible to arrive at an innovative beater 705, which has musical properties other than those of a conventional beater.

As shown here, beater 705 can be configured so that there is a distance D between a bottom 707 of the beater 705 and a bottom 712 of the drumhead DH. In some cases, a drumhead DH can be a drumhead of a kick drum. In some cases, the drumhead can have a height or diameter of about 14 inches. In some cases, the drumhead can have a height or diameter of about 16 inches. In some cases, the drumhead can have a height or diameter of about 18 inches. In some cases, the drumhead can have a height or diameter of about 20 inches. In some cases, the drumhead can have a height or diameter of about 22 inches. In some cases, the drumhead can have a height or diameter of about 24 inches. In some cases, the drumhead can have a height or diameter of about 26 inches. In some cases, a drumhead can have a height or diameter having a value within a range from 12 inches to 36 inches. In some cases, a bottom 707 of the beater is configured to contact a location on the drumhead that is a distance D from a bottom 712 of the drumhead. In some cases, the distance D is selected so that when the beater 705 contacts the drumhead DH during use, a slap effect is achieved instead of a beating effect. In some cases, the distance D has a value within a range from 1 mm to 10 mm. In some cases, the distance D has a value within a range from 2 mm to 9 mm. In some cases, the distance D has a value within a range from 3 mm to 8 mm. In some cases, the distance D has a value within a range from 4 mm to 7 mm. In some cases, the distance D has a value within a range from 5 mm to 6 mm. In some cases, the distance D has a value within a range from 0.5 mm to 15 mm. In some cases, the distance D has a value within a range from 1 mm to 15 mm.

Exemplary pedal devices disclosed herein can have their own features and advantages, so as to provide musical instrumentation having its own purposes. In some embodiments, exemplary drum pedal devices can provide a new sound that fits very well with modern pop styles, fusion, soul, and the like. In some embodiments, exemplary drum pedal devices can also provide a slightly lower beats per second (BPM) speed, which can be used by musicians in heavy music genres. When used in combination with a soft removable pad on a drum pedal device (e.g. on the beater), the sound can be much softer and can be well suited for use in jazz.

With returning reference to FIGS. 5A and 5B, it can be seen that in a conventional drum pedal design, a beater 505 hits approximately in the middle 503 of the drum head 502. The material (e.g. plastic) from point 503 begins to deform inward into the drum body. In some cases, the deformation inward (e.g. horizontal direction as shown here) into the drum at the point of impact can be up to 2 inches. At the moment of impact of the beater from the drum head, a sound wave appears, which in the drum body manifests itself in the timbre familiar to us and characteristic of such a design.

In understanding aspects of the innovative drum pedal designs disclosed herein, it is helpful to consider the concept of sound extraction. Different musical instruments have different ways of extracting sound. In wind and reed instruments, this is the air flow passing through the gap of the instrument. In string instruments such as the guitar or domra, this is plucking the strings with the fingers, striking the strings with the fingers, striking with picks and other methods. In many stringed bowed instruments such as the violin and cello, this is the movement of the bow along the strings. The hairs of the bow pull the string, then it seems to jump off the hair, weakens, and so on while the bow moves along the string. This process occurs with the frequency of the note of this string. This is where the characteristic sound of bowed instruments comes from. In brass instruments, the sound is generated in the gap of the lips in the mouthpiece. In a piano, hammers hit the strings. There are many more different instruments and ways of producing sound.

Embodiments of the present invention pertain to percussion instruments. Unlike other categories of musical instruments, percussion instruments, although not melodic (without the usual notes), have the greatest number of sound production.

As depicted in FIGS. 5A to 6B, a drum such as a bass drum can be hit with a beater. The snare drum can be hit with sticks, brushes (drum brushes). Large tympani are often hit with large mallets with soft tips. Many percussion instruments are shaken in time and hit against the palm. Also, palms and fingers are used to produce many different sounds from gongs (congas), tamas (tamas) and many other percussion instruments.

In understanding aspects of the innovative drum pedal designs disclosed herein, it is also helpful to consider the concept of attack in sound extraction. To highlight the concept of attack, the following example is provided. A digital recording of individual notes of a piano was made. Then these notes were edited. The first milliseconds of these notes were cut out, exactly the fragment of the audio file in which there is the sound of a hammer striking the strings. The main length of the cut notes visually remained the same as the original, and these slightly cut notes sounded for a long time. But without the attack, many people could not determine what kind of instrument it was. Also, because of the importance of attack, many synthesizer sound engineers face the problem of attack. Making a new sound is not difficult, but to have a beautiful and clear attack can be a difficult task.

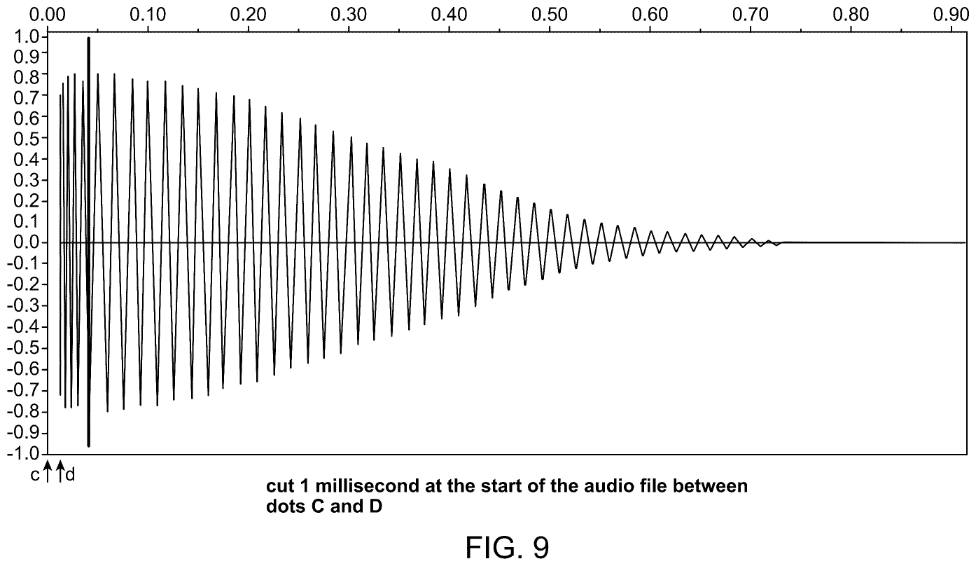

Further, it is helpful to consider the utility of attack in percussion instruments. FIG. 8 illustrates aspects of a digital audio file of the sound of a bass drum. It can be seen that the sound lasts for about 70 milliseconds. The main attack time is about 4 milliseconds (marked with the letter B between the two arrows). Next, as depicted in FIG. 9, it is possible to cut out one, the first millisecond of the audio file between points C and D in the audio editor. It can be observed with this result, a drum sound with one millisecond cut off becomes unusable in a piece of music. With this description of attacks, it is possible to have a better understanding of the importance of attack when hitting the drum head with a pedal beater.

In an instrument with a drum head, which also encompasses the bass drum, there are five standard ways of producing sound with different attacks, including (i) beater strikes (e.g. FIGS. 5A to 6B), (ii) stick strikes, (iii) striking the drum head or sliding it with brushes, (iv) striking the drum head of percussion with the palm, and (v) striking with the fingers while we dampen the drum head of percussion with the palm.

Embodiments of the present invention encompass the use of a new way of producing sound in a drum. As shown in FIGS. 1A to 4 and 6A to 7, exemplary drum pedal designs can employ the use of a beater and other novel components. According to some embodiments, aspects of the innovation lie in the shape of the beater and its mechanical effect (impact) on the drum head.

In some embodiments, the beater hits the drum head with its entire plane from the very bottom or near the bottom of the drum. This can be a significant factor in producing a desired sound. This aspect can be made possible by employing a downward displacement, almost to the floor of the beater swing axis bearings, for example as illustrated in FIGS. 1A to 4 and 6A to 7. This is the place where the beater swings. This can be compared with conventional pedals, where the beater swing axis is located at ½ the height of the pedal (e.g. as shown in FIG. 5B). In some cases, embodiments of the present invention encompass configurations having a raised bearing mechanism (e.g. relative to the beater swing axis), for example as depicted in FIG. 4.

According to some embodiments, a design of the innovative pedal with removable pads can also allow one to explore use with different materials for the beater. As illustrated in FIG. 1B, it can be seen that a pad 150A can be affixed (e.g. adhered, screwed, nailed, or the like) to the main body 150B of the beater 150. Therefore, pad 150A can be replaced with a pad of the same size made of different materials: wood, plastic, aluminum, rubber or felt. In this way, the innovative pedal configurations disclosed herein enable people to generate new and unique sounds in musical instruments.

In a sound studio, using professional equipment, comparative recordings of a conventional pedal and innovative pedals as disclosed herein were made. With the same settings, exemplary innovative pedals showed better results in terms of the main timbre and low frequencies than the conventional pedal.

In some instances, results achieved with the innovative pedal configurations disclosed herein can relate to the difference in the sound extraction in a point strike and in a strike with the innovative pedal. In a point strike, for example with sticks, their natural rebound from the membrane always occurs. A strike with the innovative pedal on the membrane tends to dampen this membrane. Playing with an innovative pedal, it is possible to achieve a low sound. In some cases, it is possible to extract different sounds, both long and short. Long sounds can be produced when the innovative pedal bounces off the drum head after hitting it and the drum head membrane resonates naturally. Short sounds can be produced when the innovative pedal remains on the membrane after hitting the membrane. When producing a short sound, the area of contact between the innovative pedal and the membrane can be significant and the area of the innovative pedal can be 10 to 30 percent of the area of the drum head. Hence, the size of the area of contact between the innovative pedal and the drum head can be significant in forming the sound of the drum and the attack sound.

All features of the described systems and devices are applicable to the described methods mutatis mutandis, and vice versa. Embodiments of the present invention encompass kits having drum pedal systems as disclosed herein. In some embodiments, the kit includes one or more drum pedal systems, along with instructions for using the system for example according to any of the methods disclosed herein.

Each reference provided herein in incorporated by reference in its entirety to the same extent as if each reference were individually incorporated by reference. Relatedly, all publications, patents, patent applications, journal articles, books, technical references, and the like mentioned in this specification are herein incorporated by reference to the same extent as if each individual publication, patent, patent application, journal article, book, technical reference, or the like was specifically and individually indicated to be incorporated by reference.

Although embodiments of the present invention have been explained in relation to one or more preferred embodiments, it is to be understood that many other possible modifications and variations can be made without departing from the spirit and scope of the invention.

For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

In this detailed description, reference is made to the accompanying figures, which form a part hereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

Although the foregoing invention has been described in some detail by way of illustration and example for purposes of clarity of understanding, one of skill in the art will appreciate that certain changes, modifications, alternate constructions, and/or equivalents may be practiced or employed as desired, and within the scope of the appended claims. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments, however, the order of description should not be construed to imply that these operations are order dependent. Additionally, the structures, systems, and/or devices described herein may be embodied as integrated components or as separate components. It is intended that the following claims define the scope of the invention and that methods and structures within the scope of these claims and their equivalents be covered thereby.

What is claimed is:

1. A drum pedal assembly, comprising:
a footplate having an anterior portion and a posterior portion;
a hoop clamp disposed at the anterior portion of the footplate, wherein the hoop clamp is configured to fix a drum relative to the footplate, the drum having a drumhead;
a footboard having an anterior portion and a posterior portion, wherein the posterior portion of the footboard is coupled with the posterior portion of the footplate via a fixed posterior hinge mechanism;
a drive mechanism in operative association with the footplate and the footboard, the drive mechanism comprising a first linkage arm, a second linkage arm, and a roller mechanism, wherein the footboard is coupled with the first linkage arm via a posterior moving hinge mechanism, wherein the first linkage arm is coupled with the second linkage arm via an intermediate moving hinge mechanism, and wherein the second linkage arm is coupled with the beater via lower portion of the beater via an anterior moving hinge mechanism;
a beater having an upper portion, a lower portion, and an attack surface,
wherein the lower portion of the beater is coupled with the anterior portion of the footplate via a fixed anterior hinge mechanism,
wherein the lower portion of the beater is in operative association with the drive mechanism, and
wherein the attack surface of the beater is configured to flatly meet a slap zone of the drumhead across an engagement interface when the beater is actuated by the drive mechanism,
wherein the engagement interface has an upper portion disposed between an upper portion of the attack surface and an upper portion of the slap zone, and a lower portion disposed between a lower portion of the attack surface and a lower portion of the slap zone,
wherein the slap zone of the drumhead extends between a lower portion of the drumhead and a central portion of the drumhead, and
wherein a bottom of the beater is configured to contact a location on the drumhead that is a distance from a bottom of the drumhead, and wherein the distance has a value within a range from 1 mm to 10 mm.

2. The drum pedal assembly according to claim 1, wherein the roller mechanism comprises a roller, and wherein the footplate comprises a track configured to engage the roller.

3. The drum pedal assembly according to claim 1, further comprising a return mechanism configured to return the beater toward a resting position when pressure on the footboard decreased.

4. The drum pedal assembly according to claim 3, wherein the return mechanism comprises a return spring.

5. The drum pedal assembly according to claim 4, wherein the return spring comprises a posterior portion that is coupled with the footplate, and an anterior portion which is coupled with the beater.

6. The drum pedal assembly according to claim 1, wherein the anterior hinge mechanism is disposed inferior to the anterior portion of the footboard throughout actuation of the beater.

7. The drum pedal assembly according to claim 1, wherein the distance has a value within a range from 2 mm to 9 mm.

8. The drum pedal assembly according to claim 1, wherein the distance has a value within a range from 3 mm to 8 mm.

9. The drum pedal assembly according to claim 1, wherein the distance has a value within a range from 4 mm to 7 mm.

10. The drum pedal assembly according to claim 1, wherein the distance has a value within a range from 5 mm to 6 mm.

11. A drum pedal assembly, comprising:
a footplate having an anterior portion and a posterior portion;
a hoop clamp disposed at the anterior portion of the footplate, wherein the hoop clamp is configured to fix a drum relative to the footplate, the drum having a drumhead;
a footboard having an anterior portion and a posterior portion, wherein the posterior portion of the footboard is coupled with the posterior portion of the footplate via a fixed posterior hinge mechanism;
a drive mechanism in operative association with the footplate and the footboard;
a beater having an upper portion, a lower portion, and an attack surface,
wherein the lower portion of the beater is coupled with the anterior portion of the footplate via a fixed anterior hinge mechanism,
wherein the lower portion of the beater is in operative association with the drive mechanism, and
wherein the attack surface of the beater is configured to flatly meet a slap zone of the drumhead across an engagement interface when the beater is actuated by the drive mechanism,
wherein the engagement interface has an upper portion disposed between an upper portion of the attack surface and an upper portion of the slap zone, and a lower portion disposed between a lower portion of the attack surface and a lower portion of the slap zone, and
wherein the slap zone of the drumhead extends between a lower portion of the drumhead and a central portion of the drumhead.

12. The drum pedal assembly according to claim 10, wherein the drive mechanism comprises a first linkage arm, a second linkage arm, and a roller mechanism, wherein the footboard is coupled with the first linkage arm via a posterior moving hinge mechanism, wherein the first linkage arm is coupled with the second linkage arm via an intermediate moving hinge mechanism, and wherein the second linkage arm is coupled with the beater via lower portion of the beater via an anterior moving hinge mechanism.

13. The drum pedal assembly according to claim 12, wherein the roller mechanism comprises a roller, and wherein the footplate comprises a track configured to engage the roller.

14. The drum pedal assembly according to claim 10, further comprising a return mechanism configured to return the beater toward a resting position when pressure on the footboard decreased.

15. The drum pedal assembly according to claim 14, wherein the return mechanism comprises a return spring.

16. The drum pedal assembly according to claim 15, wherein the return spring comprises a posterior portion that is coupled with the footplate, and an anterior portion which is coupled with the beater.

17. The drum pedal assembly according to claim 11, wherein the anterior hinge mechanism is disposed inferior to the anterior portion of the footboard throughout actuation of the beater.

18. The drum pedal assembly according to claim 11, wherein a bottom of the beater is configured to contact a location on the drumhead that is a distance from a bottom of the drumhead, and wherein the distance has a value within a range from 1 mm to 10 mm.

19. The drum pedal assembly according to claim 11, wherein a bottom of the beater is configured to contact a location on the drumhead that is a distance from a bottom of the drumhead, and wherein the distance has a value within a range from 2 mm to 9 mm.

20. The drum pedal assembly according to claim 11, wherein a bottom of the beater is configured to contact a location on the drumhead that is a distance from a bottom of the drumhead, and wherein the distance has a value within a range from distance D has a value within a range from 3 mm to 8 mm.
